(19) United States
(12) Patent Application Publication
(10) Pub. No.: US 2022/0391930 A1
(43) Pub. Date: Dec. 8, 2022

(54) SYSTEMS AND METHODS FOR AUDIENCE ENGAGEMENT

(71) Applicants: MARK SARGENT, WESTPORT, CT (US); FAITH SARGENT, WESTPORT, CT (US)

(72) Inventors: MARK SARGENT, WESTPORT, CT (US); FAITH SARGENT, WESTPORT, CT (US)

(21) Appl. No.: 17/339,490

(22) Filed: Jun. 4, 2021

(51) Int. Cl. G06Q 30/02

(52) U.S. Cl. CPC G06Q 30/0203

(57) ABSTRACT

A system for aggregating crowd sound from remote viewers for a live event is disclosed, including a user computing device in operable connection with a user network. An application server in operable communication with the user network hosts an application system for providing a system for the aggregation of crowd sound. A user interface module provides access to the application system through the user computing device and is in operable communication with a reactions database and an events database. The reactions database stores user-selectable reactions, and the events database stores live events and virtual events. A reactions interface is operable via the user interface module to permit the selection of the reactions, which are transmitted to a sound aggregation engine to generate an aggregate crowd sound, which is transmitted to the user device.

### TECHNICAL FIELD

The embodiments generally relate to computerized systems for interactive media broadcasting and more specifically to a system and method for providing collective audience engagement for a broadcast event.

### BACKGROUND

People often enjoy going to a live sporting event or performance rather than watching the same on a television; however, attending the live event can be expensive or not feasible due to necessary expenses, capacity restrictions, the location of the event, and/or health regulations prohibiting fans from attending the event. While watching the event on television has advantages, the perceived emotional response and interaction with the audience may be lacking when compared to attending the live event. In such, many who attend live events enjoy the experience of reacting along with the rest of an audience, whether reaction is cheering, clapping, booing, communication with other fans and performers, etc.

In television, producers often include audience sounds. One example is the “laugh track” and other mock audience reactions. Similarly, sporting events are often minimally filtered to allow the home-viewer to experience audience reactions during the event. This allows for the broadcast of simulated or real audience reactions to improve the remote viewing experience.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a system for aggregating crowd sound from remote viewers for a live event, including a user computing device in operable connection with a user network. An application server in operable communication with the user network hosts an application system for providing a system for the aggregation of crowd sound. A user interface module provides access to the application system through the user computing device and is in operable communication with a reactions database and an events database. The reactions database stores user-selectable and user-created reactions and the events database stores live events and virtual events. A reactions interface is operable via the user interface module to permit the selection of the reactions which are transmitted to a sound aggregation engine to generate an aggregate crowd sound, which is transmitted to the user device. The aggregate crowd sound is then played on each user device. The aggregate crowd sound may be modified for each user such that each user hears a different aggregate crowd sound on his or her user device.

The embodiments provide a system to form remote audiences for events which they attend virtually, such as by watching the event on broadcast TV or participating in video conferences or calls. Members of the remote audience can use the system to select and generate crowd sounds they would make if they were attending the event in person. Users can applaud with different levels of enthusiasm, boo, cheer, clap, groan or make other crowd sounds.

In one aspect, a code generation engine generates a code corresponding to the virtual event. The user may indicate whether the event is public or private and share the code accordingly.

In one aspect, the reactions interface is comprised of a plurality of buttons. The plurality of buttons comprise an event sound button, a user sound button, an applause button, a boo button and a groan button.

In one aspect, the applause button is quantified to produce a louder, longer and more intense virtual applause. In such, the user may select the applause button repeatedly to create louder, longer and more intense applause.

In one aspect, an events interface displays a plurality of user-generated virtual events.

In one aspect, the user indicates if the virtual event is a public virtual event or a private virtual event. The user may indicate a date and a time for the virtual event.

In one aspect, a virtual seating module receives a virtual location for each of a plurality of users to emit audio levels corresponding to the user's virtual location.

In one aspect, the sound aggregation engine receives a plurality of reactions, a plurality of recorded audio, a plurality of chats, and live crowd noise to create the aggregate crowd sound.

In one aspect, a text chat interface permits text chatting between users in the same virtual event.

In one aspect, a screen module provides a visual representation of both positive and negative contributions to the aggregate crowd sound.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a schematic for capturing remote viewer reactions to generate a social viewing experience, according to some embodiments;

FIG. 3 illustrates a block diagram of the application system, according to some embodiments;

FIG. 4 illustrates a block diagram of the server engine and modules, according to some embodiments;

FIG. 5 illustrates a screenshot of the reactions interface, wherein the user selects from a plurality of reactions, which comprise the aggregate crowd sound, according to some embodiments;

FIG. 6 illustrates a screenshot of the events interface, wherein a list of events is displayed which the user has loaded into the App by scanning QR Codes, entering alphanumeric codes or by creating such Events from scratch.

FIG. 7 illustrates a block diagram of the sound aggregation engine, according to some embodiments;

FIG. 8 illustrates a flowchart of the process for creating a virtual event, according to some embodiments; and

FIG. 9 illustrates a flowchart of a method for the generation of the virtual crowd noise heard by each user on their computing device while attending a virtual event, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a system and method to form remote audiences for events which they attend virtually, such as by watching the event on broadcast TV or participating in video conferences or calls. Members of the remote audience can use the system to select and generate crowd sounds they would make if they were attending the event in person. Users can applaud with different levels of enthusiasm, boo, cheer, clap, groan or make other crowd sounds.

The crowd sounds selected by all of the users are transmitted to the cloud and are combined to form an aggregate crowd sound, which is then transmitted back to each user. Each user hears a combination of the sound they have selected in addition to the aggregate crowd sound. The aggregate crowd sound can be modified for each user, including to reflect each user's “position” relative to other users in a hypothetical physical representation of the remote crowd (i.e., some users can be viewed as “sitting closer” to other users, and the sound heard by each can be adjusted such that sounds created by “closer” users are louder than those created by users “sitting farther away.” Thus, users hear the sounds created by the entire remote audience as if they were attending a live event together.

Any user can utilize the system, which may be provided on a mobile application, website, etc., to create a virtual event which corresponds to a real-world event. The system generates unique QR codes, alphanumeric codes, and links for each event which can be used to invite others to join the remote audience for that event. The codes and links can be shared via the mobile application, by text, email, or by simply displaying the QR code on a TV, computer screen, or in print. Scanning the QR code instantly loads the event into the system, such that users can join the remote audience for that event. A “batch event” feature allows a host to assign a group of related events, for example, a sports team's entire season of games or every episode of a TV show, to a single set of codes so all of the related events can be added to a user's event queue with a single scan, code, or link. The system may be utilized to form any number of events simultaneously, each with any number of remote audience members. The system provides a single platform for every conceivable remote audience need.

The system will dramatically increase fan engagement. Users will enjoy forming and contributing to the remote audience and interacting with other fans via the chat function. The host can use a chat function to provide additional information to users and a poll function to ask users to vote or provide input during events. A broadcaster, for example, could ask users who they believe will win a sporting event, which candidate did best in a debate, or to pick the winner of a TV talent contest. The results will be instantly tabulated and can be revealed to crowd during the event via the system interface.

The system will also collect immediate audience feedback that can be used to improve broadcasts and real-world events. Further, the system will provide detailed insight into user preferences, which can be utilized for targeted marketing, and the system can be used to market directly to users, including in a manner that is deeply intertwined with the related real-world event.

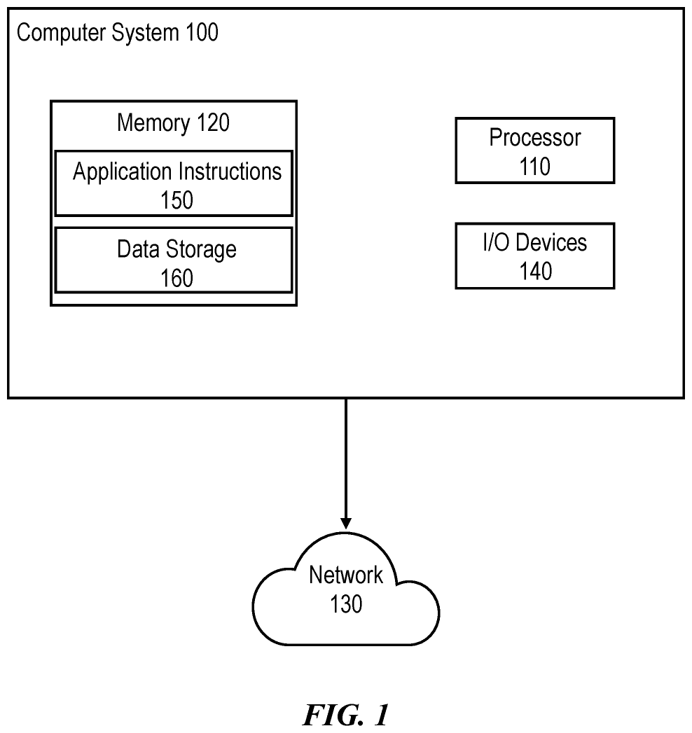

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile tablet device, a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, Python, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

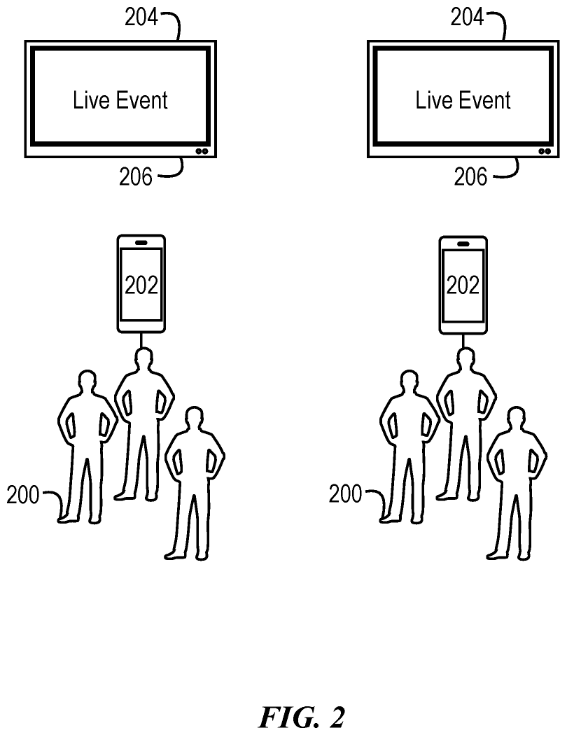

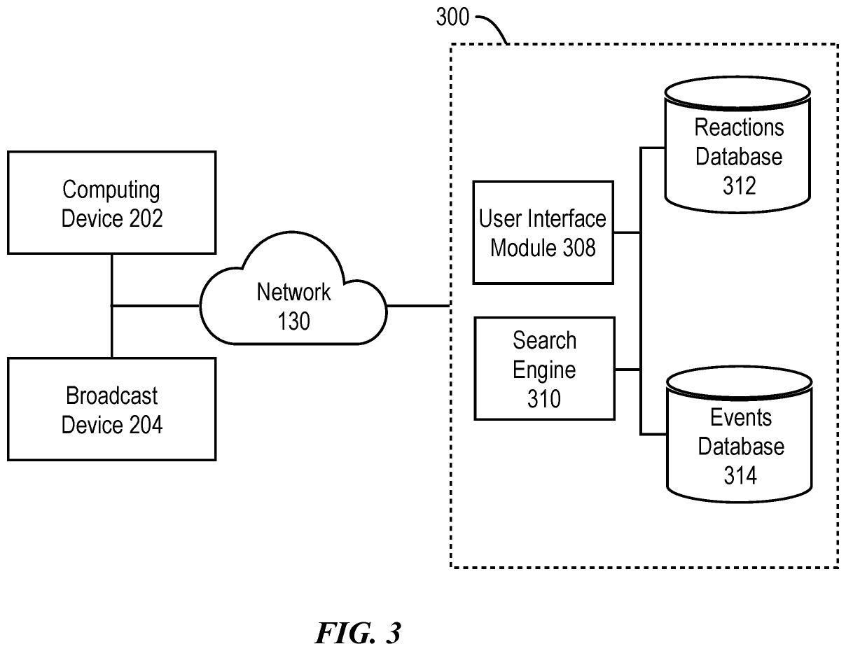

FIG. 2 illustrates a schematic for capturing remote viewer reactions to generate a social viewing experience. Users 200 view the event via a computing device 202 remotely while interacting with the application interface. The application interface allows users 200 to select from a plurality of reactions (including some created by the users), which are aggregated and stored in a reactions database 312 (FIG. 3). The aggregated reactions are combined together to a new set of output signals along with an aggregate crowd sound. The aggregate crowd sound is transmitted back to the user's 200 computing device 202 and/or broadcast device 204, which broadcasts the aggregate crowd sound as well as reactions selected by the user 200. The aggregate crowd sound and user-selected reactions are broadcast by the speakers 206 of a broadcast device 204 such that the user 200 hears the aggregate crowd sound gathered from a plurality of users 200 viewing the event, as well as the user's 200 selected reactions.

The user 200 may utilize a text chat feature, which is created for each event. The chat feature is provided on the application interface and allows users 200 who are not physically present at the event to form a virtual crowd and exchange text messages while hearing the aggregate crowd sounds as if they were physically present. In some embodiments, the aggregate crowd sound can be played over speakers where the event is taking place, so athletes, performers, or others can hear the sound of the remote audience.

In some embodiments, the computing device 202 may operate a microphone to capture noise created by each user 200 while watching the live event. The noise captured by the microphone may be transmitted to the system to generate aggregate crowd noises.

As used herein, the term “reactions” relates to audible audience sounds, which are often made during a live event, such as cheering, clapping, whistling, groaning, booing, conversation, chanting, stomping, and the like. One skilled in the arts will readily understand that various audible noises can be made and replicated virtually by the system.

FIG. 3 illustrates a block diagram of the application system 300 in operable communication with the computing device 202 and the broadcast device 204 via a network 130. The computing device 202 operates the application system to permit the user to interact with the various features of the system provided herein. The computing device 202 and broadcast device 204 may be separate devices, or may be the same device, such that the user 200 watches the event and interacts with the system on the same device. Alternatively, the user may watch the event on the broadcast device 204 while using the computing device 202 to interact with the system. The application system 300 includes a user interface module 308 to permit the user to interact with the system, such as by creating a live event, interacting with other users, and selecting reactions. A search engine 310 allows the user to search a reactions database 312 and an events database 314. The reactions database 312 stores a plurality of reactions, which includes audio data corresponding to an audience sound, such as clapping, cheering, applauding, booing, yelling, chanting, groaning, etc. The reactions database may include sounds recorded by or audio data provided by the users. The reactions database may be stored in multiple physical devices simultaneously. The user may then utilize the user interface module 308 to select from the stored reactions in the reactions database 312 to generate an output signal which is transmitted to the computing device 202 and/or the broadcast device 204. The events database 314 stores a plurality of events such as sporting events, live performances, etc. The events are associated with a code, which is transmitted to each user 200 to permit the users to enter the event virtually and contribute to the aggregate crowd noise.

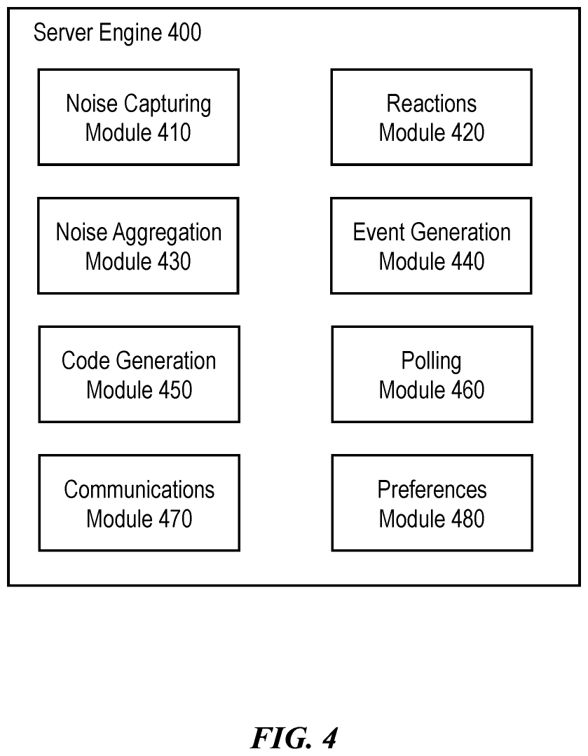

FIG. 4 illustrates a block diagram of the server engine 400 and modules, including a noise capturing module 410, a reactions module 420, a noise aggregation module 430, an event generation module 440, a code generation module 450, a polling module 460, a communications module 470, and a preferences module 480. The noise capturing module 410 receives audio signals from the computing device and transmits the audio signal to the system. For example, the user can record a cheer by vocalizing the cheer into the microphone included in or attached to the noise capturing module. Then computing device in which the noise capturing module is included will record the audio signals of the cheer and transmit the audio signals to the system. The noise capturing module 410 may also capture non-audible signals input by the user, such as by the user typing a reaction into the computing device (e.g., typing “go team”), which is interpreted by the system and transmitted to the broadcast device as a corresponding audio signal. The reactions module 420 permits the user to select from a plurality of reactions on the user interface. For example, the user is provided with a plurality of buttons, each corresponding to a reaction. The noise aggregation module 430 aggregates noises and reactions transmitted by each user and aggregates the noises into an aggregate crowd sound, which is output by the speakers of the computing and/or broadcast device. The event generation module 440 permits one or more users to create a virtual event and invite other users to the event. The virtual event may correspond to a live event such that a group of users can watch simultaneously while inputting reactions and noises, which are aggregated and transmitted to the computing and/or broadcast device. The code generation module 450 generates a unique code for the virtual event, which is transmitted to users who are invited to the virtual event. A polling module 460 permits users to poll other users during the event. For example, the polling module 460 allows the user to create a poll asking users who they believe will win the event. A communications module 470 permits the utilization of a text chat feature provided during the event. In such, users can text chat with one another while utilizing the other functionalities described herein. The preferences module 480 allows the user to input user preferences, such as which events they would like to access, which users they would like to interact with, reaction settings, etc.

In some embodiments, the event generation module 440 allows a group of users to create a virtual event in which they can interact with one another. The event generation module will assign a unique QR code, alphanumeric code and internet link that event. The creator of the virtual event may invite (by sharing the codes and/or links for the event) other users to join the event. The group of invited users may be limited (e.g., made up of friends and family), or it may comprise a larger group (e.g., fans of a particular sports team). For example, a sports team may create a group that is accessible via a publicly available QR code, such that fans of the sports team may interact with one another in the virtual event which corresponds to a real-world competition in which includes the sports team.

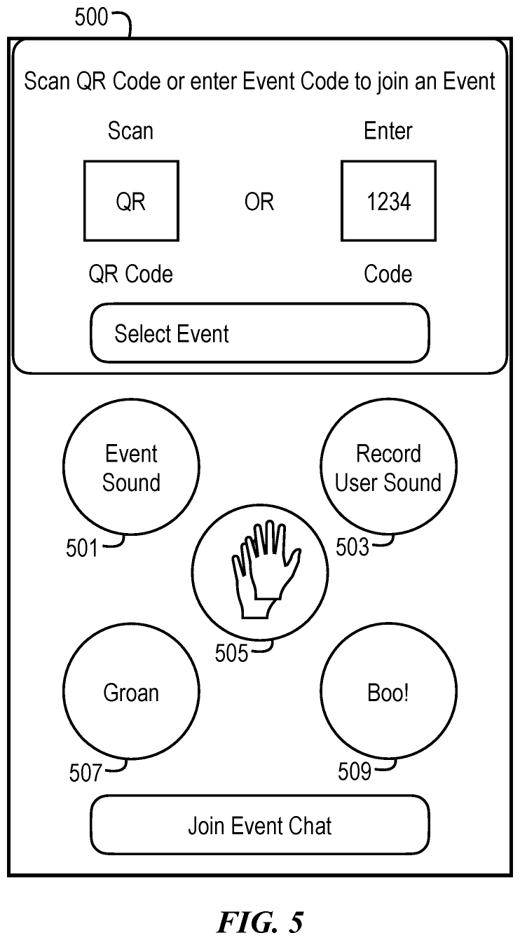

FIG. 5 illustrates a screenshot of the reaction interface 500 wherein the user can select from a plurality of buttons to transmit a reaction to the system. For example, the user may select an event sound button 501, a record user sound button 503, an applause reaction button 505, a groan reaction button 507, and a boo reaction button 509. The user may select to interact with an event sound via the event sound button 501, which will play a sound assigned by the user who created the event on that user's device and transmit the same sound to the system so that it is included in the aggregate crowd sound. Selecting the record user sound button 503 allows the user to record sounds using the microphone of their computing device. In such, the user may record chanting, cheering, or other reactions, which are transmitted to the system and added to the reactions database where they can subsequently be incorporated in the aggregate crowd sound. Similarly, user may select the applause button 505, which corresponds to a clapping sound, cheering sound, or other sound or combination of sounds that are associated with applause. The user may select the applause button 505 repeatedly to create louder or more frequent applause sounds. The groan and boo buttons 507,509 can be selected by the user to transmit audio associated with groaning or booing. In each case, the selected reactions are transmitted to the system and are incorporated in the resulting aggregate crowd sound.

In further reference to FIG. 5, the user may select to scan a QR code or enter an alphanumeric code associated with a virtual event to enter the user into the virtual event. In such, the user may enter a virtual event with a group of friends or fans of a particular team. Once the user selects a join event chat button, they are able to text chat with other users in the same virtual event via the communications module 470.

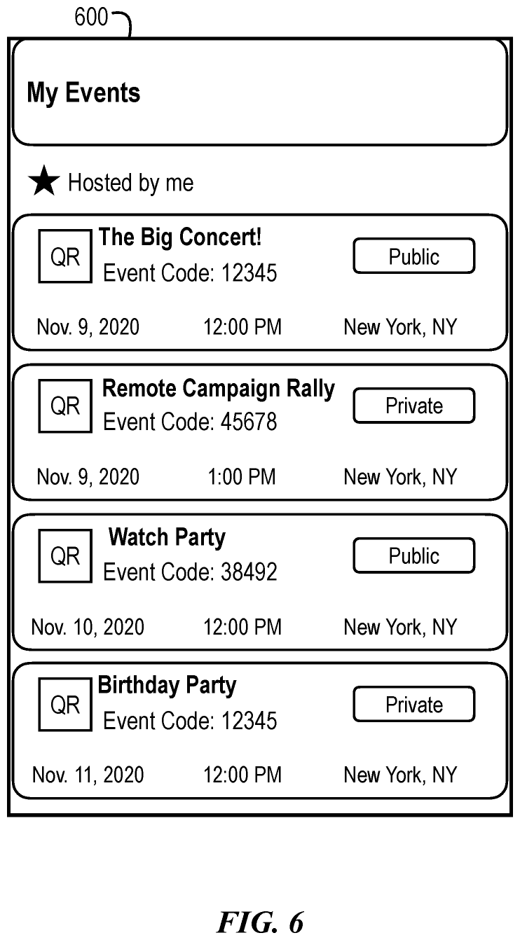

FIG. 6 illustrates an events interface 600, which displays the various virtual events with which the user may interact. Each virtual event corresponds to a live event. The virtual event may be hosted by the user or a third-party user who has created the virtual event. Each virtual event indicates whether the virtual event is public (i.e., made accessible to any user of the system) or private (i.e., attendees must be invited to the virtual event). Each event is scheduled by the creator of the event inputting a date and time of the event, including a start time and an end time. Once the event is created, the code generation module 450 generates a QR code, and an alphanumeric code, and an internet link providing access to the event.

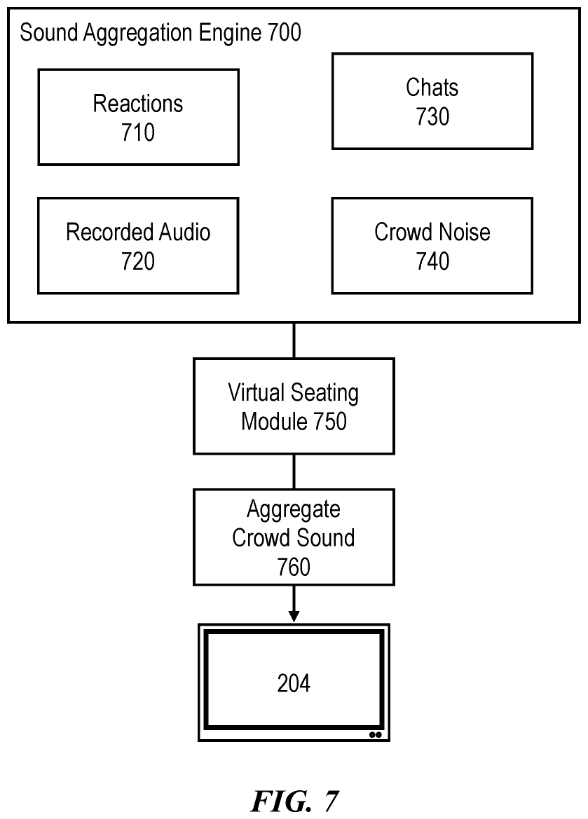

FIG. 7 illustrates a block diagram of the sound aggregation engine 700, which allows the system to receive input from each user (e.g., reactions 710, recorded audio 720, chats 730, and crowd noise 740), which are aggregated to form the aggregate crowd sound 760. The aggregate crowd sound 760 is a compilation of reactions 710 submitted by the user(s) selecting the reaction buttons 501,505,507,509, recorded user sound button 503, and may also include sounds created by inputs chats (see FIG. 5) and sound received from the live event (i.e., real crowd noise 740). A virtual seating module 750 may position users in a virtual seat. This may be created by generating a virtual map of the event location and positioning remote users in a virtual seat so as to define a hypothetical “distance” and angle of each user relative to each other user, just each member of a real audience is sounded by other audience members different distances and directions away. In such, the virtual seating module 750 allows the sound aggregation engine 700 to transmit audio based on the user's virtual location. For example, a group of users may be placed in a virtual section such that the noises generated by the group of users is louder when compared to other virtual group seated in different section. This creates a realistic aggregate crowd sound, which is transmitted to the user's broadcast device 204 or computing device 202. The aggregate crowd sound heard by each user could be unique to that user, reflecting such user's virtual distance and direction relative to other users providing reactions.

The sound aggregation engine employs a continuous real-time algorithm which measures the frequency and intensity of sound reactions entered by users via the reaction buttons 501, 503, 505, 507 and 509 and the real crowd noise 740 and then weights such sounds by the number of total users (and the percentage of active users, i.e., those who have entered a reaction button within a preset period of time) and then creates a mapping which assigns different weights (which are associated with volumes) to each of the sounds stored in the reactions database). Those weights (and, if necessary, the associated sounds) are transmitted back to each user's computing device 202 where such weights may be further adjusted (e.g., to ensure that each user hears the sound associated with the reaction that specific user has selected, and to reflect the distance and direction in the virtual seat mapping of that user relative to other users who have provided reactions).

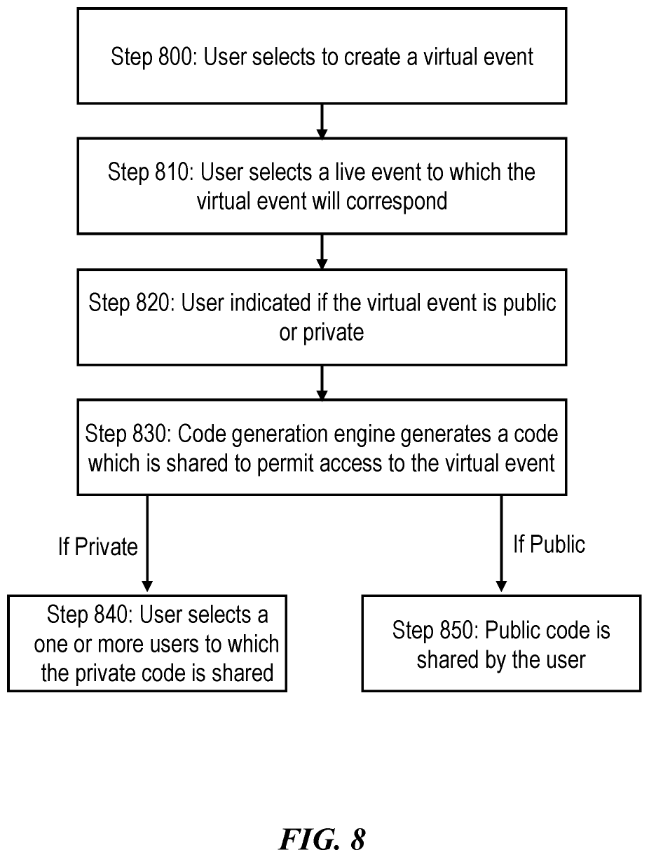

FIG. 8 illustrates a method for creating a virtual event. In step 800, the user selects to create a virtual event. In step 810, the user selects a live event occurring in the present or future. The system then corresponds the virtual event with the live event. In step 820, the user indicates if the virtual event is public or private. In step 830, the code generation engine 450 generates a code, which is shared by the user to permit other users to enter the virtual event. If the event is private, the user selects a plurality of users with whom to share the code in step 840. If the event is public, the user shares the code such that any other user can access and utilize the code to enter the event in step 850.

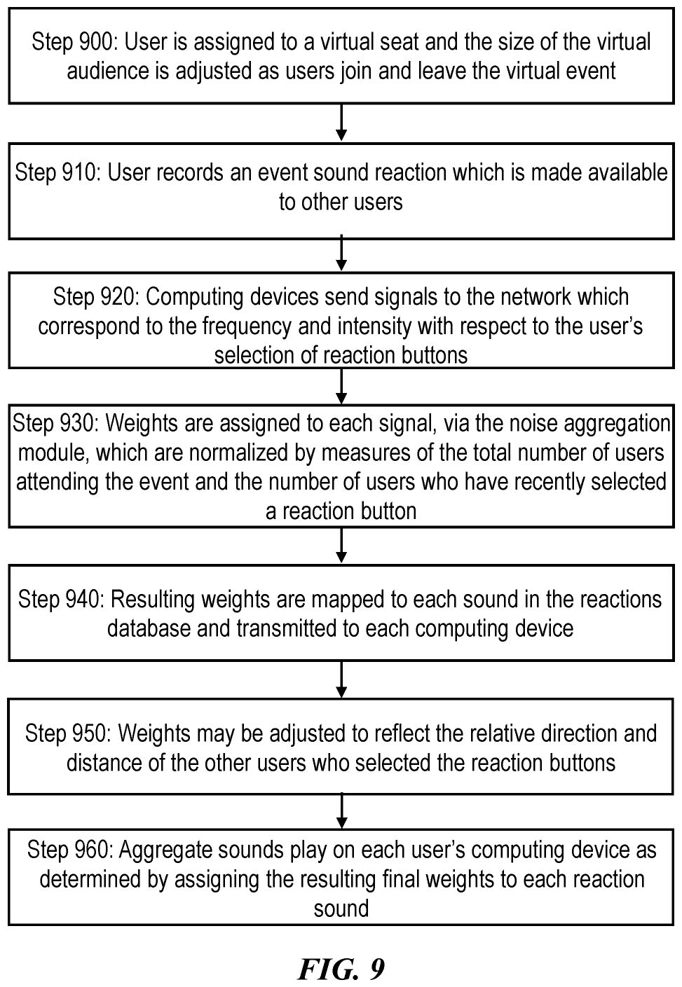

In reference to FIG. 9, a flowchart showing a method for the generation of the virtual crowd noise heard by each user on their computing device while attending a virtual event is illustrated. In step 900, when each user joins the event, the user is assigned to a virtual seat in a virtual version of what a hypothetical physical audience consisting of the number of users who have joined the event. The size of the hypothetical physical audience is adjusted as users join and leave the event. Each user's virtual seat assignment defines a distance and direction of each such user relative to every other user. In step 910, when a user creates an event, the user may record an event sound reaction which is common to all users who join the event and which is available via the event sound reaction button for every user. Likewise, each user who joins the event may record a user sound which is available to each such user via the user sound button for the event. In step 920, during the course of the event, each user's computing device sends signals to the network which correspond to the frequency and intensity with respect to which each such user is selecting each reaction button. Likewise, signals associated with the real crowd noise are sent to the network. In step 930, all of these signals are submitted to a real-time algorithm at the noise aggregation module, which assigns weights which corresponds to each sound included in the reactions database. These gross weights are then normalized by measures of the total number of users attending the event and/or the number or percentage of users who have selected a reaction button recently. The smallest weights may be reduced to zero (i.e., sounds selected by a very small part of the virtual audience may be viewed as “drowned out” by the rest of the crowd and are thus dropped.) In step 940, the resulting final weights are mapped to each sound in the reactions database and are transmitted to each user's computing device. In step 950, the weights may be further adjusted by each user's computing device to reflect the relative direction and distance of the other users who selected the reaction buttons inherent in such weightings from each such user. In step 960, an aggregate sound plays on each user's computing device as determined by assigning the resulting final weightings to each reaction sound included in the reactions database.

In some embodiments, the live event venue includes a display screen, which is in operable communication with the system. Aggregate crowd sound may be displayed as a “sound meter” to provide a visual representation of the aggregate amount of engagement (or the aggregate for categories of sounds included in the reactions database) received from the remote viewers. In such, the system connects remote viewers with the athletes/performers at the live event as well as with in-person attendees at the live event.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for aggregating crowd sound from remote viewers for a live event, the system comprising:
at least one user computing device in operable connection with a user network;
an application server in operable communication with the user network, the application server configured to host an application system for providing a system for the aggregation of crowd sound, the application system having a user interface module for providing access to the application system through the user computing device, the user interface module in operable communication with: a reactions database and an events database, the reactions database storing one or more user-selectable reactions and the events database storing one or more live events and one or more virtual events; and
a reactions interface operable via the user interface module to permit the selection of the one or more reactions, wherein the one or more reactions are transmitted via the application server to a sound aggregation engine to generate an aggregate crowd sound and to transmit the aggregate crowd sound to the at least one user device.

2. The system of claim 1, wherein the reactions interface is comprised of a plurality of buttons.

3. The system of claim 2, wherein the plurality of buttons comprise an event sound button, a user sound button, an applause button, a boo button and a groan button.

4. The system of claim 1, further comprising an events interface to display a plurality of user-generated virtual events.

5. The system of claim 4, wherein the user indicates if the virtual event is a public virtual event or a private virtual event.

6. The system of claim 5, wherein the user indicates a date and a time for the virtual event.

7. The system of claim 1, further comprising a virtual seating module to receive a virtual location for each of a plurality of users to emit audio levels corresponding to the user's virtual location relative to other users.

8. A system for aggregating crowd sound from remote viewers for a live event, the system comprising:
at least one user computing device in operable connection with a user network;
an application server in operable communication with the user network, the application server configured to host an application system for providing a system for the aggregation of crowd sound, the application system having a user interface module for providing access to the application system through the user computing device, the user interface module in operable communication with: a reactions database and an events database, the reactions database storing one or more user-selectable reactions and the events database storing one or more live events and one or more virtual events;
a reactions interface operable via the user interface module to permit the selection of the one or more reactions, wherein the one or more reactions are transmitted via the application server to a sound aggregation engine to generate an aggregate crowd sound and to transmit the aggregate crowd sound to the at least one user device; and
an events interface to permit the generation, via an event generation module, of a virtual event, wherein the virtual event corresponds to a live event.

9. The system of claim 8, further comprising a code generation engine to generate a unique QR code, alphanumeric code and internet link corresponding to the virtual event.

10. The system of claim 9, wherein the codes and link permit access to the virtual event.

11. The system of claim 8, wherein the reactions interface is comprised of a plurality of buttons.

12. The system of claim 11, wherein the plurality of buttons comprise an event sound button, a user sound button, and an applause button.

13. The system of claim 12, wherein the applause button is quantified to produce a louder virtual applause.

14. The system of claim 8, further comprising an events interface to display a plurality of user-generated virtual events.

15. The system of claim 14, wherein the user indicates if the virtual event is a public virtual event or a private virtual event.

16. The system of claim 15, wherein the user indicates a date and a time for the virtual event.

17. The system of claim 8, further comprising a virtual seating module to receive a virtual location for each of a plurality of users to emit audio levels corresponding to the user's virtual location relative to other users.

18. The system of claim 8, wherein the sound aggregation engine receives a plurality of reactions, a plurality of recorded audio, a plurality of chats, and live crowd noise to create the aggregate crowd sound.

19. The system of claim 8, further comprising a chat interface to permit chatting between users in the same virtual event.

20. A method for aggregating crowd sound from remote viewers for a live event, the method comprising the steps of:
assigning a virtual seat to each of a plurality of users;
adjusting an audience size corresponding to the plurality of users who join and leave a virtual event;
sending, via the computing device, signals to a network, the signals corresponding to a frequency and an intensity in which the users select one or more reaction buttons;
assigning weights to each signal;
normalizing the signal via a noise aggregation module;
mapping the signal to each selection of the one or more reaction buttons and transmitting the signal to the computing device;
adjusting the weights to reflect a direction and distance of the users assigned to the virtual seats; and
playing, via the computing device, the signals as aggregate sounds.
